(19) United States
(12) Patent Application Publication
(10) Pub. No.: US 2025/0337958 A1
(43) Pub. Date: Oct. 30, 2025

(54) METHOD, APPARATUS, AND MEDIUM FOR VIDEO PROCESSING

(71) Applicant: Bytedance Inc., Los Angeles, CA (US)

(72) Inventors: Jizheng XU, Los Angeles, CA (US); Ye-Kui Wang, Los Angeles, CA (US); Li Zhang, Los Angeles, CA (US)

(21) Appl. No.: 19/258,850

(22) Filed: Jul. 2, 2025

Related U.S. Application Data
(63) Continuation of application No. PCT/US2024/010209, filed on Jan. 3, 2024.
(60) Provisional application No. 63/478,304, filed on Jan. 3, 2023.
(60) Provisional application No. 63/437,078, filed on Jan. 4, 2023.
(60) Provisional application No. 63/480,161, filed on Jan. 17, 2023.
(60) Provisional application No. 63/480,659, filed on Jan. 19, 2023.
(60) Provisional application No. 63/481,305, filed on Jan. 24, 2023.
(60) Provisional application No. 63/497,912, filed on Apr. 24, 2023.

(51) Int. Cl. H04N 19/80; H04N 19/186; H04N 19/70; H04N 19/85

(52) U.S. Cl. CPC H04N 19/80; H04N 19/186; H04N 19/70; H04N 19/85

(57) ABSTRACT

Embodiments of the present disclosure provide a solution for video processing. A method for video processing is proposed. The method comprises: performing a conversion between a video and a bitstream of the video, wherein a neural-network post-processing filter (NNPF) is applied on at least one picture associated with the video, and if a color format of the at least one picture is a first color format without a chroma component, at least one indication associated with a chroma input tensor for the NNPF is absent from the bitstream.

### CROSS REFERENCE

This application is a continuation of International Application No. PCT/US2024/010209, filed on Jan. 3, 2024, which claims the benefit of U.S. Provisional Application No. 63/478,304 filed on Jan. 3, 2023, U.S. Provisional Application No. 63/437,078 filed on Jan. 4, 2023, U.S. Provisional Application No. 63/480,161 filed on Jan. 17, 2023, U.S. Provisional Application No. 63/480,659 filed on Jan. 19, 2023, U.S. Provisional Application No. 63/481,305 filed on Jan. 24, 2023, U.S. Provisional Application No. 63/497,912 filed on Apr. 24, 2023. The entire contents of these applications are hereby incorporated by reference in their entireties.

### FIELDS

Embodiments of the present disclosure relates generally to video processing techniques, and more particularly, to a neural-network post-processing filter (NNPF).

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: performing a conversion between a video and a bitstream of the video, wherein a neural-network post-processing filter (NNPF) is applied on at least one picture associated with the video, and if a color format of the at least one picture is a first color format without a chroma component, at least one indication associated with a chroma input tensor for the NNPF is absent from the bitstream.

According to the method in accordance with the first aspect of the present disclosure, in a case where the input for the NNPF is in a color format without a chroma component, at least one indication associated with a chroma input tensor for the NNPF is not indicated in the bitstream. Thereby, the proposed method can advantageously reduce the redundant indications, and thus the coding efficiency can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: performing a conversion between the video and the bitstream, wherein a neural-network post-processing filter (NNPF) is applied on at least one picture associated with the video, and if a color format of the at least one picture is a first color format without a chroma component, at least one indication associated with a chroma input tensor for the NNPF is absent from the bitstream.

In a fifth aspect, a method for storing a bitstream of a video is proposed. The method comprises: performing a conversion between the video and the bitstream, wherein a neural-network post-processing filter (NNPF) is applied on at least one picture associated with the video, and if a color format of the at least one picture is a first color format without a chroma component, at least one indication associated with a chroma input tensor for the NNPF is absent from the bitstream; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an illustration of luma data channels;

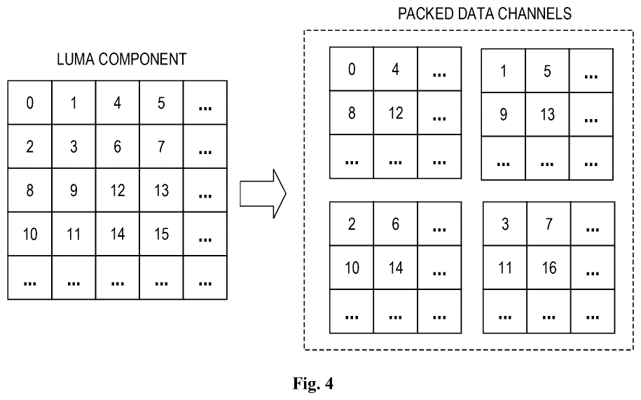

FIG. 5 illustrates a flowchart of a method for video processing in accordance with embodiments of the present disclosure; and

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

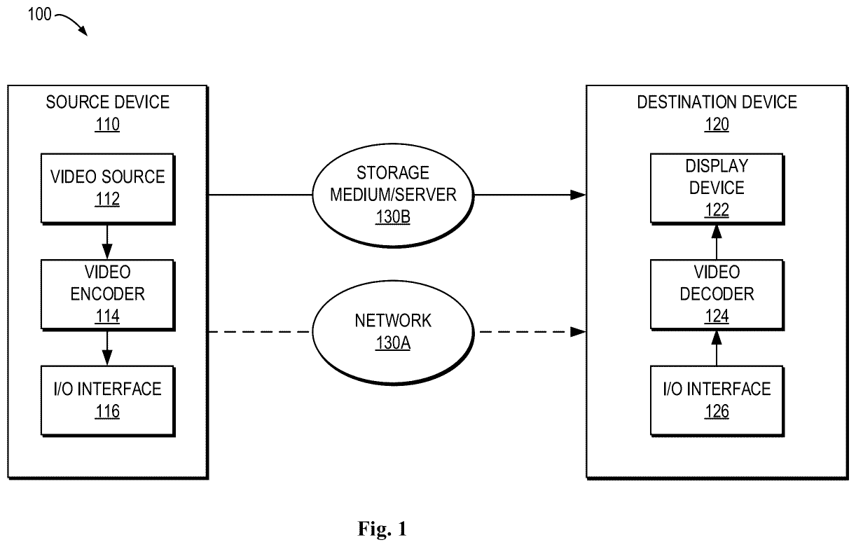

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

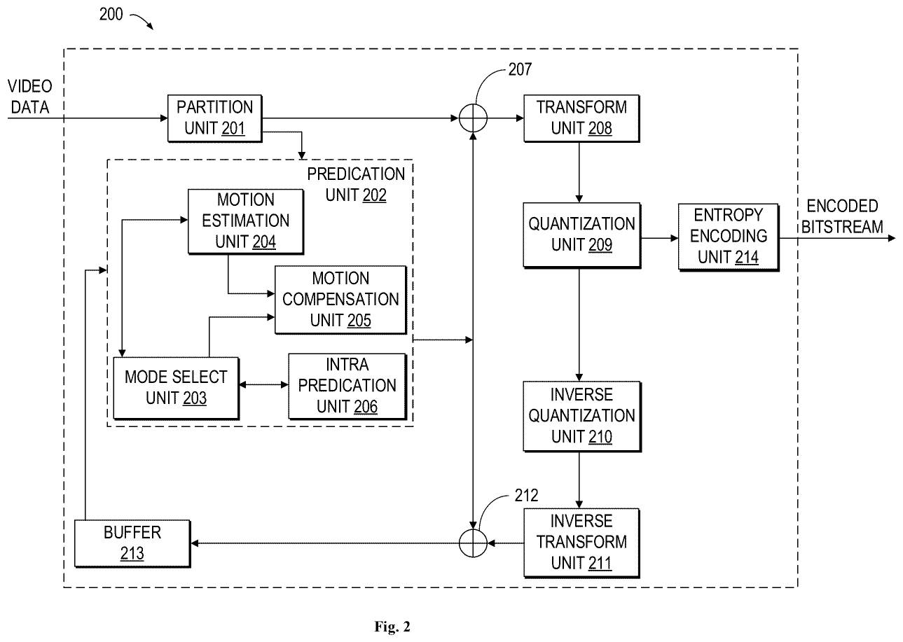

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

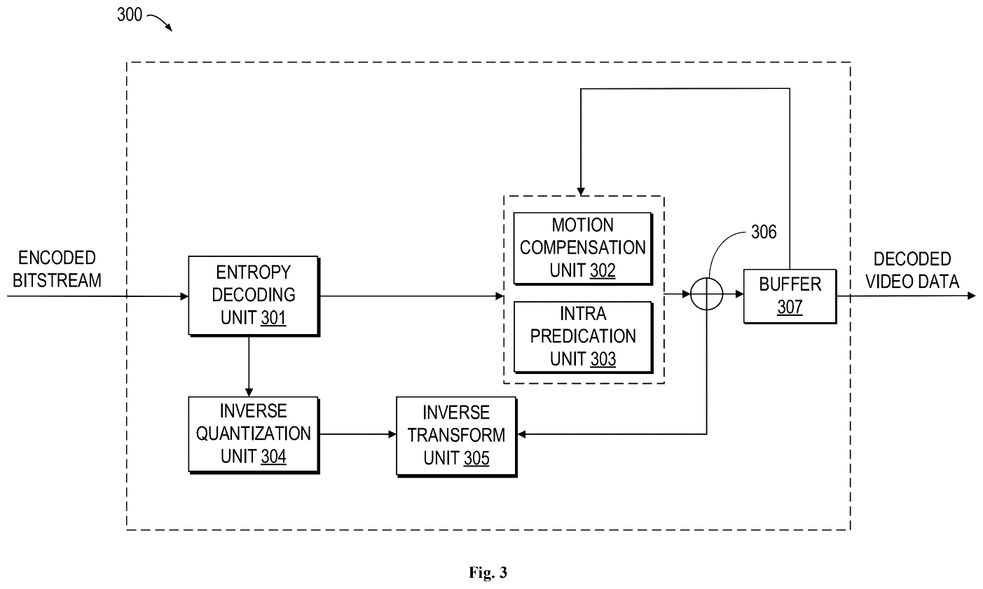

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to image/video coding technologies. Specifically, it is related to the definition and signaling of new neural-network post-processing filtering purposes, as well as their combinations with the current purposes, and the range and constraint of various syntax elements. The ideas may be applied individually or in various combinations, for video bitstreams coded by any codec, e.g., the versatile video coding (VVC) standard and/or the versatile SEI messages for coded video bitstreams (VSEI) standard.

### 2. Abbreviations

APS Adaptation Parameter Set
AU Access Unit
CLVS Coded Layer Video Sequence
CLVSS Coded Layer Video Sequence Start
CRC Cyclic Redundancy Check
CVS Coded Video Sequence
FIR Finite Impulse Response
IRAP Intra Random Access Point
NAL Network Abstraction Layer
PPS Picture Parameter Set
PU Picture Unit
RASL Random Access Skipped Leading
SEI Supplemental Enhancement Information
STSA Step-wise Temporal Sublayer Access
VCL Video Coding Layer
VSEI versatile supplemental enhancement information (Rec. ITU-T H.274|ISO/IEC 23002-7)
VUI Video Usability Information
VVC versatile video coding (Rec. ITU-T H.266|ISO/IEC 23090-3)

### 3. Introduction

### 3.1. Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266|ISO/IEC 23090-3) and the associated Versatile Supplemental Enhancement Information for coded video bitstreams (VSEI) standard (ITU-T H.274|ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

### 3.2. SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274|ISO/IEC 23002-7.

### 3.3. Signaling of Neural-Network Post-Filters

An excerpt from the specification of two SEI messages for signaling of neural-network post-filters is as follows.

### 4. Problems

The current design for the neural-network post-filter characteristics (NNPFC) SEI message has the following problems.
1) It does not support applications with 4:0:0 input, for example, colorization for black and white video.
2) It does not support applications that may need bit-depth increase, for example, SDR to HDR.
3) The range of syntax element nnpfc_num_input_pics_minus2 is not specified.
4) The range of syntax elements nnpfc_interpolated_pics[i] is not specified.
5) All instances of nnpfc_interpolated_pics[i] may be equal to 0, which leads to no frame rate change from the input video to the output. It contradicts with the frame rate upsampling purpose.
6) numOutputPics does not take the input pictures into account, which makes changes to the input pictures in some applications impossible.
7) The process StoreOutputTensors( ), for deriving sample values in the filtered output sample arrays from the output tensor outputTensor uses the wrong range in the process.
8) When the purpose indicates colorization, some syntax elements are missing, some syntax elements are present but are useless, some constraints are missing, and some conversion processes are missing.
9) Whether to signal syntax elements of luma or chroma bit depth should depend on input or output methods and orders.
10) Some syntax and semantics may need to be adjusted to enable non-4:0:0 input for colourization.
11) Chroma sample location should be specified when input is in 4:0:0 format for colourization.

### 5. Detailed Solutions

To solve the above problems, methods as summarized below are disclosed. The solutions should be considered as examples to explain the general concepts and should not be interpreted in a narrow way. Furthermore, these solutions can be applied individually or combined in any manner.
1) To solve problem 1, a new purpose or sub-purpose may be specified to describe the behavior of NNPF for 4:0:0 input.
   a. In one example, alternatively, furthermore, combination of chroma format change for 4:0:0 inputs and/or frame rate and/or picture resolution and/or bitdepth change is further allowed, e.g, being indicated in a SEI message.
   b. When the input is in 4:0:0 format and there is no color format change, nnpfc_out_order_idc shall not be equal to 0.
   c. In one example, when the NNPF input is in the 4:0:0 format for which the value of the variable ChromaFormatIdc is equal to 0, the NNPF purpose shall not be of chroma upsampling.
      i. Alternatively, when the NNPF purpose is of chroma upsampling, the NNPF input shall not be in the 4:0:0 format.
   d. In one example, when the NNPF input is in the 4:0:0 format, syntax element(s) related to the chroma input tensor are not signaled.
      i. In one example, when the NNPF input is in the 4:0:0 format, no syntax element indicating the bit depth of chroma sample values in the input integer tensor is signaled.
      ii. In one example, when the NNPF input is in the 4:0:0 format, syntax element(s) indicating the chroma type and/or chroma padding values are not signaled.
   e. In one example, the forementioned condition “when the NNPF input is in the 4:0:0 format” may be replaced by “when the NNPF input is in the 4:4:4 format, separate plane coding is applied and the current input is the luma component”.
2) To solve problem 2, a new purpose may be specified for bit-depth increase.
   a. In one example, one syntax element may be signaled to indicate the difference between the input bitdepth and output bitdepth.
      i. In one example, a syntax element nnpfc_delta_bitdepth_minus1 is signaled, and nnpfc_delta_bitdepth_minus1 plus 1 specifies the output bitdepth minus the input bitdepth.
   b. In one example, when the purpose is bit-depth increase, the network output shall have a higher bit-depth than the network input given that both input and output are in the format of integer values.
   c. In one example, when the purpose is bit-depth increase, the network output shall have a higher bit-depth than the bit depth of the decoded video output by the video decoder, given that network output is in the format of integer values.
   d. In one example, when the purpose is related to bit-depth increase, it is required that both the network input and output are in the format of integer values and the network output shall have a higher bit-depth than the network input.
      i. In one example, that the network output has a higher bit-depth than the network input means that there are no colour components of which the bit-depth of output is smaller than the bit-depth of input and at least for one colour component, the bit-depth of output is larger than the bit-depth of input.
      ii. In one example, that the network output has a higher bit-depth than the network input means that for all colour components, the bit-depth values of the output are larger than the input's.
   e. In one example, when the purpose is related to bit-depth increase, it is required that both the network input and output are in the format of integer values and the network output shall have a higher bit-depth than the decoded video output.
      i. In one example, that the network output has a higher bit-depth than the deoded video output means that there are no colour components of which the bit-depth of network output is smaller than the bit-depth of decoded video output and at least for one colour component, the bit-depth of network output is larger than the bit-depth of decoded video output.
      ii. In one example, that the network output has a higher bit-depth than the decoded video ooutput means that for all colour components, the bit-depth values of network output are larger than the decoded video output's.
   f. In one example, when the purpose is related to bit-depth increase, it is required that the network output is in the format of integer values and the network output shall have a higher bit-depth than the decoded video output.
      i. In one example, that the network output has a higher bit-depth than the deoded video output means that there are no colour components of which the bit-depth of network output is smaller than the bit-depth of decoded video output and at least for one colour component, the bit-depth of network output is larger than the bit-depth of decoded video output.
      ii. In one example, that the network output has a higher bit-depth than the decoded video ooutput means that for all colour components, the bit-depth values of network output are larger than the decoded video output's.
3) To solve problem 3, the range of syntax element nnpfc_num_input_pics_minus2 is specified to be 0 to N, inclusive.
   a. In one example, N is 2.
   b. In one example, N is 6.
   c. In one example, N is 14.
   d. In one example, N is 30.
   e. In one example, N is 62.
   f. In one example, N is 126.
   g. In one example, N is 254.
   h. Alternatively, N is 2\hat{ }K−2, where K is a positive integer.
4) To solve problem 4, the range of syntax elements nnpfc_interpolated_pics[i] is specified to be 0 to N, inclusive.
   a. In one example, N is 1.
   b. In one example, N is 2.
   c. In one example, N is 4.
   d. In one example, N is 8.
   e. In one example, N is 16.
   f. In one example, N is 32.
   g. In one example, N is 64.
   h. Alternatively, N is 2\hat{ }K, where K is a positive integer.
5) To solve problem 5, it is constrained that at least one of nnpfc_interpolated_pics[i] for i in the range of 0 to nnpfc_num_input_pics_minus2, inclusive, shall be greater than 0.
   a. Alternatively, when nnpfc_interpolated_pics[i] for i in the range of 0 to nnpfc_num_input_pics_minus2−1 are all equal to 0 nnpfc_interpolated_pics[nnpfc_num_input_pics_minus2] is derived to be none zero.
      i. In one example, nnpfc_interpolated_pics[nnpfc_num_input_pics_minus2] is derived to be 1.
6) To solve problem 6, it is proposed to take the number of input pictures into account during the calculation of numOutputPics.
   a. In one example, numOutputPics is the number of input pictures plus the total number of interpolated pictures.
7) To solve problem 7, it is proposed to use numOutputPics in the process StoreOutputTensors( ), for deriving sample values in the filtered output sample arrays from the output tensor outputTensor.
8) To solve problem 2, the NNPF purpose may indicate bit depth increase (also referred to as bit depth upsampling), possibly along with other types of upsampling. Furthermore, one or more of the following aspects apply.
   a. In one example, regardless of whether the NNPF purpose indicates bit depth increase, it is required that, when the bit depth of one colour component of the network output is greater than the bit depth of the corresponding colour component of the network input, then the bit depth of each of other colour components of the network output shall be greater than or equal to the bit depth of the corresponding colour component of the network input.
   b. In one example, when the purpose indicates bit-depth increase, it is required that both the network input and output are in the format of integer values and the network output shall have a higher bit depth than the network input.
      i. In one example, the network output having a higher bit depth than the network input means that for each colour component, the bit depth of network output is greater than the bit depth of the corresponding colour component of the network input.
      ii. In one example, the network output having a higher bit depth than the network input means that for at least one colour component, the bit depth of network output is greater than the bit depth of the corresponding colour component of the network input.
   c. In one example, when the purpose indicates bit-depth increase, it is required that both the network input and output are in the format of integer values and the network output shall have a higher bit depth than the cropped output pictures output by the video decoder.
      i. In one example, the network output having a higher bit depth than the cropped output pictures means that for each colour component, the bit depth of network output is greater than the bit depth of the corresponding colour component of the cropped output pictures.
      ii. In one example, the network output having a higher bit depth than the cropped output pictures means that for at least one colour component, the bit depth of network output is greater than the bit depth of the corresponding colour component of the cropped output pictures.
   d. In one example, when the purpose indicates bit-depth increase, it is required that the network output is in the format of integer values and the network output shall have a higher bit depth than the cropped output pictures output by the video decoder.
      i. In one example, the network output having a higher bit depth than the cropped output pictures means that for each colour component, the bit depth of network output is greater than the bit depth of the corresponding colour component of the cropped output pictures.
      ii. In one example, the network output having a higher bit depth than the cropped output pictures means that for at least one colour component, the bit depth of network output is greater than the bit depth of the corresponding colour component of the cropped output pictures.
9) To solve problem 8, one or more of the following syntax or semantics changes are specified:
   a. In one example, the value of a bit of nnpf_purpose, e.g., corresponding to 0x020 (i.e. bit 5) indicates whether the purpose is of colorization.
      i. In one example, when nnpfc_purpose & 0x20 is not equal to 0, it indicates that the purpose is with colorization.
      ii. In one example, when nnpfc_purpose & 0x20 is equal to 0, it indicates that the purpose is no colorization or without colorization.
   b. In one example, when the purpose indicates colorization, it is required that the input to the network shall be in the 4:0:0 format, for which the value of the variable ChromaFormatIdc is equal to 0.
   c. In one example, when the purpose indicates colorization, there should be chroma output by the NNPF.
      i. In one example, when the purpose indicates colorization, nnpfc_out_order_idc shall not be equal to 0.
   d. In one example, when the purpose indicates colorization, the chroma component sample values may be inferred to be equal to 0 or 0.5 or 1 when the tensor input is of real numbers.
   e. In one example, when the purpose indicates colorization, the chroma component sample values may be inferred to be equal to 0 or 1<<(inpTensorBitDepthc−1) or 1<<(inpTensorBitDepthc)−1 when the tensor input is of integer numbers, where inpTensorBitDepthc is the bit depth of chroma sample values in the input integer tensor.
   f. In one example, when the purpose indicates colorization and ChromaFormatIdc is equal to 0, there may be luma input only.
      i. In one example, when the purpose indicates colorization and ChromaFormatIdc is equal to 0, nnpfc_inp_order_idc shall be equal to 0.
   g. In one example, when the purpose indicates colorization and ChromaFormatIdc is equal to 0, only having chroma input is not allowed.
      i. In one example, when the purpose indicates colorization and ChromaFormatIdc is equal to 0, nnpfc_inp_order_idc shall not be equal to 1.
   h. In one example, when the purpose indicates colorization, it may be required that the purpose does not indicates chroma upsampling at the same time.
      i. In one example, when nnpfc_purpose & 0x20 is not equal to 0, it is required that nnpfc_purpose & 0x02 shall be equal to 0.
   i. In one example, when the purpose indicates chroma upsampling, it may be required that the purpose does not indicates colorization at the same time.
      i. In one example, when nnpfc_purpose & 0x02 is not equal to 0, it is required that nnpfc_purpose & 0x20 shall be equal to 0.
   j. In one example, the purpose indicating colorization and the purpose indicating chroma upsampling shall be mutually exclusive.
      i. In one example, ((nnpfc_purpose & 0x02)!=0) && ((nnpfc_purpose & 0x20)!=0) shall be equal to 0.
   k. In one example, when the purpose indicates colorization, an indication, e.g., a two-bit syntax element named nnpfc_out_colour_format_idc, is signaled in the NNPFC SEI message, to specify whether the colour format of the output of the NNPF is the 4:2:0, 4:2:2, or 4:4:4 format.
   l. In one example, when the purpose indicates colorization, an indication, e.g., a two-bit syntax element named nnpfc_out_colour_format_idc, is signaled in the NNPFC SEI message, to specify the values of the variables outSubWidthC and outSubHeightC.
      i. In one example, furthermore, the following are specified: nnpfc_out_colour_fomrat_idc equal to 1 specifies that outSubWidthC and outSubHeightC are both equal to 2. nnpfc_out_colour_fomrat_idc equal to 2 specifies that outSubWidthC is equal to 2 and outSubHeightC is equal to 1. nnpfc_out_colour_fomrat_idc equal to 3 specifies that outSubWidthC and outSubHeightC are both equal to 1. The value of nnpfc_out_colour_fomrat_idc shall not be equal to 0.
      ii. In one example, furthermore, it is specified that, when nnpfc_purpose & 0x02 and nnpfc_purpose & 0x20 are both equal to 0, outSubWidthC is inferred to be equal to SubWidthC and outSubHeightC is inferred to be equal to SubHeightC.
10) To solve problem 9, one or more of the following syntax or semantics changes are specified:
   a. When the method of ordering the sample arrays of a cropped decoded output picture as one of the input pictures to the post-processing filter indicates no luma matrix is present, the syntax element indicating luma input bit depth should not be signaled.
      i. In one example, when nnpfc_inp_order_idc is equal to 1, nnpfc_inp_tensor_luma_bitdepth_minus8 shall not be signaled.
   b. When the method of ordering the sample arrays of a cropped decoded output picture as one of the input pictures to the post-processing filter indicates no chroma matrix is present, the syntax element indicating chroma input bit depth should not be signaled.
      i. In one example, when nnpfc_inp_order_idc is equal to 0, nnpfc_inp_tensor_chroma_bitdepth_minus8 shall not be signaled.
   c. In one example, the syntax element(s) to indicate the method of ordering the sample arrays of a cropped decoded output picture as one of the input pictures to the post-processing filter should be signaled before the syntax element(s) to indicate the luma and/or chroma input bit depth.
      i. In one example, nnpfc_inp_order_idc should be signaled before nnpfc_inp_tensor_luma_bitdepth_minus8 and/or nnpfc_inp_tensor_chroma_bitdepth_minus8 in the syntax table.
   d. When the output order of samples resulting from the post-processing filter indicates no luma matrix is present, the syntax element indicating luma input bit depth should not be signaled.
      i. In one example, when nnpfc_out_order_idc is equal to 1, nnpfc_out_tensor_luma_bitdepth_minus8 shall not be signaled.
   e. When the output order of samples resulting from the post-processing filter indicates no chroma matrix is present, the syntax element indicating chroma input bit depth should not be signaled.
      i. In one example, when nnpfc_out_order_idc is equal to 0, nnpfc_out_tensor_chroma_bitdepth_minus8 shall not be signaled.
   f. In one example, the syntax element(s) to indicate the output order of samples resulting from the post-processing filter should be signaled before the syntax element(s) to indicate the luma and/or chroma output bit depth.
      i. In one example, nnpfc_out_order_idc should be signaled before nnpfc_out_tensor_luma_bitdepth_minus8 and/or nnpfc_out_tensor_chroma_bitdepth_minus8 in the syntax table.
11) To solve problem 10, one or more of the following syntax or semantics changes are specified:
   a. When the NNPF purpose indicates colourization, output chroma format may be indicated by a syntax element only when the input is of 4:0:0 format.
   b. Alternatively, when the NNPF purpose indicates colourization, output chroma format may be indicated by a syntax element regardless the input chroma format.
12) To solve problem 11, one or more of the following syntax or semantics changes are specified:
   a. One flag is signaled to indicate whether chroma sample location is signaled or not.
   b. When the purpose indicates colourization and input is in 4:0:0 format, the flag described in the above sub-item shall be true (indicating that chroma sample location is signaling).
   c. When chroma sample location is not signaled in NNPF SEI messages, it is inferred to be the same as that in VUI.

### 6. Embodiments

Below are some example embodiments for the solution aspects summarized above in Section 5.

Most relevant parts that have been added or modified are shown by using bolded words (e.g., this format indicates added text), and some of the deleted parts are shown by using words in italics between double curly brackets (e.g., {{this format indicates deleted text}}). There may be some other changes that are editorial in nature and thus not highlighted. It should be understood that only markings in this section are intended to emphasize at least part of proposed changes.

### 5 6.1. Embodiment 1

This embodiment is for solution item 1 and all its subitems summarized above in Section 5.

### 6.2. Embodiment 2

This embodiment is for solution item 2 and all its subitems summarized above in Section 5.

### 6.3. Embodiment 3

This embodiment is for solution item 1 and 2 and all its subitems summarized above in Section 5.

### 6.4. Embodiment 4

This embodiment is for solution item 3 and all its subitems summarized above in Section 5.

8.28.2 Neural-network post-filter characteristics SEI message semantics
nnpfc_num_input_pics_minus2 plus 2 specifies the number of decoded
output pictures used as input for the post-processing filter. The value
of nnpfc_{—}num_{—}input_{—}pics_{—}minus2 shall be in the range of 0 to 62,
inclusive.

### 6.5. Embodiment 5

This embodiment is for solution item 4 and all its subitems summarized above in Section 5.

8.28.2 Neural-network post-filter characteristics SEI message semantics
nnpfc_interpolated_pics[ i ] specifies the number of interpolated pictures
generated by the post-processing filter between the i-th and the ( i + 1 )-th
picture used as input for the post-processing filter. The value of
nnpfc_{—}interpolated_{—}pics[ i ] shall be in the range of 0 to 32, inclusive.

### 6.6. Embodiment 6

This embodiment is for solution item 5 and all its subitems summarized above in Section 5.

nnpfc_interpolated_pics[ i ] specifies the number of interpolated pictures
generated by the post-processing filter between the i-th and the ( i + 1 )-th
picture used as input for the post-processing filter. The value of
nnpfc_{—}interpolated_{—}pics[ i ] shall be in the range of 0 to 32, inclusive.
At least one of nnpfc_{—}interpolated_{—}pics[ i ] for i in the range of 0 to
nnpfc_{—}num_{—}input_{—}pics_{—}minus2, inclusive, shall be greater than 0.

### 6.7. Embodiment 7

This embodiment is for solution item 6 and all its subitems summarized above in Section 5.

```
8.28.2 Neural-network post-filter characteristics SEI message semantics
nnpfc_interpolated_pics[ i ] specifies the number of interpolated pictures generated by the post-processing
filter between the i-th and the ( i + 1 )-th picture used as input for the post-processing filter.
The variables numInputPics, specifying the number of pictures used as input for the post-processing filter,
and numOutputPics, specifying the total number of pictures resulting from the post-processing filter, are
derived as follows:
  if( nnpfc_purpose = = 5 ) {
    numInputPics = nnpfc_num_input_pics_minus2 + 2
    for( i = 0, numOutputPics = {{0}}numInputPics; i <= numInputPics − 2; i++ ) (76)
      numOutputPics += nnpfc_interpolated_pics[ i ]
  } else
    numInputPics = 1
```

### 6.8. Embodiment 8

This embodiment is for solution item 7 and all its subitems summarized above in Section 5.

```
8.28.2 Neural-network post-filter characteristics SEI message semantics
The process StoreOutputTensors( ), for deriving sample values in the filtered output sample arrays
FilteredYPic, FilteredCbPic, and FilteredCrPic from the output tensor outputTensor for a given vertical
sample coordinate cTop and a horizontal sample coordinate cLeft specifying the top-left sample location
for the patch of samples included in the input tensor, is specified as follows:
  for( i = 0; i < {{numInputPics}}numOutputPics; i++ ) {
    if( nnpfc_out_order_idc = = 0 )
      for( yP = 0; yP < outPatchHeight; yP++)
        for( xP = 0; xP < outPatchWidth; xP++ ) {
          yY = cTop * outPatchHeight / inpPatchHeight + yP
          xY = cLeft * outPatchWidth / inpPatchWidth + xP
          if ( yY < nnpfc_pic_height_in_luma_samples && xY <
  nnpfc_pic_width_in_luma_samples )
            if( !nnpfc_component_last_flag )
              FilteredYPic[ i ][ xY ][yY ] = outputTensor[ 0 ][ i ][ 0 ][ yP ][ xP ]
            else
              FilteredYPic[ i ][ xY ][ yY ] = outputTensor[ 0 ][ i ][ yP ][ xP ][ 0 ]
        }
    else if( nnpfc_out_order_idc = = 1 ) (83)
      for( yP = 0; yP < outPatchCHeight; yP++)
        for( xP = 0; xP < outPatchCWidth; xP++ ) {
          xSrc = cLeft * horCScaling + xP
          ySrc = cTop * verCScaling + yP
          if ( ySrc < nnpfc_pic_height_in_luma_samples / outSubHeightC &&
              xSrc < nnpfc_pic_width_in_luma_samples / outSubWidthC )
            if( !nnpfc_component_last_flag ) {
              FilteredCbPic[ i ][ xSrc ][ ySrc ] = outputTensor[ 0 ][ i ][ 0 ][ yP ][ xP ]
              FilteredCrPic[ i ][ xSrc ][ ySrc ] = outputTensor[ 0 ][ i ][ 1 ][ yP ][ xP ]
            } else {
              FilteredCbPic[ i ][ xSrc ][ ySrc ] = outputTensor[ 0 ][ i ][ yP ][ xP ][ 0 ]
              FilteredCrPic[ i ][ xSrc ][ ySrc ] = outputTensor[ 0 ][ i ][ yP ][ xP ][ 1 ]
            }
        }
    else if( nnpfc_out_order_idc = = 2 )
      for( yP = 0; yP < outPatchHeight; yP++)
        for( xP = 0; xP < outPatchWidth; xP++ ) {
          yY = cTop * outPatchHeight / inpPatchHeight + yP
          xY = cLeft * outPatchWidth / inpPatchWidth + xP
          yC = yY / outSubHeightC
          xC = xY / outSubWidthC
          yPc = ( yP / outSubHeightC ) * outSubHeightC
          xPc = ( xP / outSubWidthC ) * outSubWidthC
          if ( yY < nnpfc_pic_height_in_luma_samples && xY <
  nnpfc_pic_width_in_luma_samples)
            if( !nnpfc_component_last_flag ) {
              FilteredYPic[ i ][ xY ][ yY ] = outputTensor[ 0 ][ i ][ 0 ][ yP ][ xP ]
              FilteredCbPic[ i ][ xC ][ yC ] = outputTensor[ 0 ][ i ][ 1 ][ yPc ][ xPc ]
              FilteredCrPic[ i ][ xC ][ yC ] = outputTensor[ 0 ][ i ][ 2 ][ yPc ][ xPc ]
            } else {
              FilteredYPic[ i ][ xY ][ yY ] = outputTensor[ 0 ][ i ][ yP ][ xP ][ 0 ]
              FilteredCbPic[ i ][ xC ][ yC ] = outputTensor[ 0 ][ i ][ yPc ][ xPc ][ 1 ]
              FilteredCrPic[ i ][ xC ][ yC ] = outputTensor[ 0 ][ i ][ yPc ][ xPc ][ 2 ]
            }
        }
    else if( nnpfc_out_order_idc = = 3 )
      for( yP = 0; yP < outPatchHeight; yP++ )
        for( xP = 0; xP < outPatchWidth; xP++ ) {
          ySrc = cTop / 2 * outPatchHeight / inpPatchHeight + yP
          xSrc = cLeft / 2 * outPatchWidth / inpPatchWidth + xP
          if ( ySrc < nnpfc_pic_height_in_luma_samples / 2 &&
              xSrc < nnpfc_pic_width_in_luma_samples / 2 )
            if( !nnpfc_component_last_flag ) {
              FilteredYPic[ i ][ xSrc * 2 ][ ySrc * 2 ] = outputTensor[ 0 ][ i ][ 0 ][ yP ][ xP ]
              FilteredYPic[ i ][ xSrc * 2 + 1 ][ ySrc * 2 ] = outputTensor[ 0 ][ i ][ 1 ][ yP ][ xP ]
              FilteredYPic[ i ][ xSrc * 2 ][ ySrc * 2 + 1 ] = outputTensor[ 0 ][ i ][ 2 ][ yP ][ xP ]
              FilteredYPic[ i ][ xSrc * 2 + 1][ ySrc * 2 + 1 ] =
  outputTensor[ 0 ][ i ][ 3 ][ yP ][ xP ]
              FilteredCbPic[ i ][ xSrc ][ ySrc ] = outputTensor[ 0 ][ i ][ 4 ][ yP ][ xP ]
              FilteredCrPic[ i ][ xSrc ][ ySrc ] = outputTensor[ 0 ][ i ][ 5 ][ yP ][ xP ]
            } else {
              FilteredYPic[ i ][ xSrc * 2 ][ ySrc * 2 ] = outputTensor[ 0 ][ i ][ yP ][ xP ][ 0 ]
              FilteredYPic[ i ][ xSrc * 2 + 1 ][ ySrc * 2 ] = outputTensor[ 0 ][ i ][ yP ][ xP ][ 1 ]
              FilteredYPic[ i ][ xSrc * 2 ][ ySrc * 2 + 1 ] = outputTensor[ 0 ][ i ][ yP ][ xP ][ 2 ]
              FilteredYPic[ i ][ xSrc * 2 + 1][ ySrc * 2 + 1 ] =
  outputTensor[ 0 ][ i ][ yP ][ xP ][ 3 ]
              FilteredCbPic[ i ][ xSrc ][ ySrc ] = outputTensor[ 0 ][ i ][ yP ][ xP ][ 4 ]
              FilteredCrPic[ i ][ xSrc ][ ySrc ] = outputTensor[ 0 ][ i ][ yP ][ xP ][ 5 ]
            }
        }
  }
```

### 6.9. Embodiment 9

This embodiment is for solution item 2 and all its subitems summarized above in Section 5.

### 6.10. Embodiment 10

This embodiment is for solution item 11 and all its subitems summarized above in Section 5.

### 6.11. Embodiment 11

This embodiment is for solution item 11 and all its subitems summarized above in Section 5.

### 6.12. Embodiment 12

This embodiment is for solution item 12 and all its subitems summarized above in Section 5.

More details of the embodiments of the present disclosure will be described below which are related to neural-network post-processing filter. As used herein, the term “neural-network post-processing filter” and “neural-network post-filter” may be used interchangeably. The embodiments of the present disclosure should be considered as examples to explain the general concepts and should not be interpreted in a narrow way. Furthermore, these embodiments can be applied individually or combined in any manner.

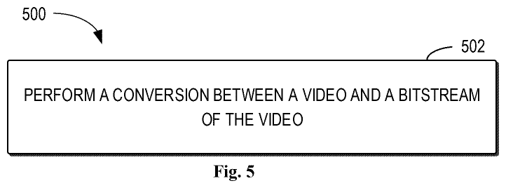

FIG. 5 illustrates a flowchart of a method 500 for video processing in accordance with some embodiments of the present disclosure. As shown in FIG. 5, at 502, a conversion between a video and a bitstream of the video is performed. In some embodiments, the conversion may include encoding the video into the bitstream. Alternatively or additionally, the conversion may include decoding the video from the bitstream.

A neural-network post-processing filter (NNPF) is applied on at least one picture associated with the video. For example, the at least one picture may be used as an input for the NNPF. In some embodiments, the at least one picture may comprise at least one decoded picture of the video. Alternatively, the at least one picture may comprise at least one cropped decoded picture of the video. For example, the decoded picture and/or the cropped decoded picture may be outputted by a decoder that decodes the video from the bitstream. In some further embodiments, the at least one picture may comprise an output of a further NNPF used to filter one or more decoded pictures or cropped decoded pictures of the video. For example, the NNPF is concatenated with the further NNPF. It should be understood that the possible implementations of the at least one picture associated with the video described here are merely illustrative and therefore should not be construed as limiting the present disclosure in any way.

If a color format of the at least one picture is a first color format without a chroma component, at least one indication associated with a chroma input tensor for the NNPF is absent from the bitstream. For example, the first color format may comprise 4:0:0 format, which is also referred to as “monochrome”.

In some embodiments, the at least one indication may comprise a first indication indicating a bit depth of a chroma sample value in the input tensor. For example, the first indication comprises a syntax element nnpfc_inp_tensor_chroma_bitdepth_minus8. Additionally or alternatively, the at least one indication may comprise at least one second indication indicating at least one of a chroma type or a chroma value used for padding. For example, the at least one second indication may comprise a syntax element nnpfc_cb_padding_val and/or a syntax element nnpfc_cr_padding_val. It should be understood that the name for an indication and/or a syntax element is used only for illustration rather than limitation, the indication(s) and the syntax element(s) mentioned throughout the present disclosure may be represented by any other suitable string different from that mentioned in this disclosure. The scope of the present disclosure is not limited in this respect.

In view of the above, in a case where the input for the NNPF is in a color format without a chroma component, at least one indication associated with a chroma input tensor for the NNPF is not indicated in the bitstream. Thereby, the proposed method can advantageously reduce the redundant indications, and thus the coding efficiency can be improved.

In some embodiments, if a scheme of ordering sample arrays of one of the at least one picture to form an input tensor to the NNPF indicates no luma matrix is present in the input tensor, a third indication indicating a bit depth of a luma sample value in the input tensor is not present in the bitstream. By way of example rather than limitation, the scheme of ordering the sample arrays may be indicated by a syntax element nnpfc_inp_order_idc, and the third indication may comprise a syntax element nnpfc_inp_tensor_luma_bitdepth_minus8. For example, when the syntax element nnpfc_inp_order_idc is equal to 1, the syntax element nnpfc_inp_tensor_luma_bitdepth_minus8 shall not be signaled.

In some additional or alternative embodiments, if the scheme of ordering sample arrays of one of the at least one picture to form an input tensor to the NNPF indicates no chroma matrix is present in the input tensor, a first indication indicating a bit depth of a chroma sample value in the input tensor may be not present in the bitstream. By way of example rather than limitation, the scheme of ordering the sample arrays may be indicated by a syntax element nnpfc_inp_order_idc, and the first indication may comprise a syntax element nnpfc_inp_tensor_chroma_bitdepth_minus8. For example, when the syntax element nnpfc_inp_order_idc is equal to 0, the syntax element nnpfc_inp_tensor_chroma_bitdepth_minus8 shall not be signaled.

In some embodiments, in the bitstream, a fourth indication indicating a scheme of ordering sample arrays of one of the at least one picture to form an input tensor to the NNPF may precede a first indication indicating a bit depth of a chroma sample value in the input tensor. Additionally or alternatively, the fourth indication may precede a third indication indicating a bit depth of a luma sample value in the input tensor. By way of example rather than limitation, the fourth indication may comprise a syntax element nnpfc_inp_order_idc, the first indication may comprise a syntax element nnpfc_inp_tensor_chroma_bitdepth_minus8, and the third indication may comprise a syntax element nnpfc_inp_tensor_luma_bitdepth_minus8. For example, the syntax element nnpfc_inp_order_idc should be signaled before the syntax element nnpfc_inp_tensor_luma_bitdepth_minus8 and/or the syntax element nnpfc_inp_tensor_chroma_bitdepth_minus8 in the syntax table for the bitstream.

In some embodiments, if an output order of samples from the NNPF indicates no luma matrix is present in an output tensor of the NNPF, a fifth indication indicating a bit depth of a luma sample value in the output tensor may be not present in the bitstream. By way of example rather than limitation, the output order of the samples may be indicated by a syntax element nnpfc_out_order_idc, and the fifth indication may comprise a syntax element nnpfc_out_tensor_luma_bitdepth_minus8. For example, when the syntax element nnpfc_out_order_idc is equal to 1, the syntax element nnpfc_out_tensor_luma_bitdepth_minus8 shall not be signaled.

In some embodiments, if an output order of samples from the NNPF indicates no chroma matrix is present in an output tensor of the NNPF, a sixth indication indicating a bit depth of a chroma sample value in the output tensor may be not present in the bitstream. By way of example rather than limitation, the output order of the samples may be indicated by a syntax element nnpfc_out_order_idc, and the sixth indication comprises a syntax element nnpfc_out_tensor_chroma_bitdepth_minus8. For example, when the syntax element nnpfc_out_order_idc is equal to 0, the syntax element nnpfc_out_tensor_chroma_bitdepth_minus8 shall not be signaled.

In some embodiments, in the bitstream, a seventh indication indicating an output order of samples from the NNPF may precede a fifth indication indicating a bit depth of a luma sample value in an output tensor of the NNPF. Additionally or alternatively, a seventh indication indicating an output order of samples from the NNPF may precede a sixth indication indicating a bit depth of a chroma sample value in an output tensor of the NNPF. By way of example rather than limitation, the seventh indication may comprise a syntax element nnpfc_out_order_idc, the fifth indication may comprise a syntax element nnpfc_out_tensor_luma_bitdepth_minus8, and the sixth indication may comprise a syntax element nnpfc_out_tensor_chroma_bitdepth_minus8. For example, the syntax element nnpfc_out_order_idc should be signaled before the syntax element nnpfc_out_tensor_luma_bitdepth_minus8 and/or the syntax element nnpfc_out_tensor_chroma_bitdepth_minus8 in the syntax table for the bitstream.

In some embodiments, if a bit depth of a sample value in a color component of an output tensor of the NNPF is greater than a bit depth of a sample value in a corresponding color component of an input tensor of the NNPF, a bit depth of a sample value in each of other components of the output tensor is greater than or equal to a bit depth of a sample value in a corresponding color component of the input tensor. For example, regardless of whether the NNPF purpose comprises bit depth increase, it is required that: when the bit depth of one color component of the network output tensor is greater than the bit depth of the corresponding color component of the network input tensor, then the bit depth of each of other color components of the network output tensor shall be greater than or equal to the bit depth of the corresponding color component of the network input.

In some embodiments, if a purpose of the NNPF comprises colorization of the at least one picture, at least one chroma matrix shall be present in an output tensor of the NNPF. For example, if a purpose of the NNPF comprises colorization of the at least one picture, a value of a seventh indication indicating an output order of samples from the NNPF is not equal to a first value (such as 0 or the like). By way of example rather than limitation, the seventh indication may comprise a syntax element nnpfc_out_order_idc.

In some further embodiments, if the purpose of the NNPF comprises colorization of the at least one picture, the bitstream may comprise an eighth indication indicating a color format of an output of the NNPF. For example, when the NNPF purpose comprises colorization, output chroma format may be indicated by a syntax element regardless the input chroma format.

In some alternative embodiments, if the purpose of the NNPF comprises colorization of the at least one picture and a color format of the at least one picture is 4:0:0 format, the bitstream comprises the eighth indication indicating a color format of an output of the NNPF. For example, in a case where the NNPF purpose comprises colorization, output chroma format may be indicated by a syntax element only when the input is in 4:0:0 format. By way of example rather than limitation, the eighth indication may comprise a syntax element nnpfc_out_colour_format_idc.

In some embodiments, the bitstream may comprise a ninth indication indicating whether a location of a chroma sample in an output of the NNPF is present in the bitstream. By way of example rather than limitation, the ninth indication may comprise syntax a element named as nnpfc_separate_chroma_sample_loc_present_flag or nnpfc_chroma_loc_info_present_flag. For example, if a purpose of the NNPF comprises colorization of the at least one picture and a color format of the at least one picture is 4:0:0 format, the ninth indication may indicate that the location of the chroma sample is present in the bitstream.

In some embodiments, if a location of a chroma sample in an output of the NNPF is not present in an NNPF Supplemental Enhancement Information (SEI) message in the bitstream, the location of the chroma sample may be inferred to be the same as a location of a chroma sample indicated in video usability information (VUI) in the bitstream.

In some embodiments, if the color format of the at least one picture is the first color format (e.g., the 4:0:0 format or the like) and is not changed by the NNPF, a matrix different from a luma matrix is present in an output tensor of the NNPF. For example, When the input is in 4:0:0 format and there is no color format change, a syntax element nnpfc_out_order_idc shall not be equal to 0. The syntax element nnpfc_out_order_idc indicates the output order of samples resulting from the post-processing filter, and the syntax element nnpfc_out_order_idc equal to 0 indicates only the luma matrix is present in the output tensor, thus the number of channels is 1.

In some embodiments, if the color format of the at least one picture is the first color format, a purpose of the NNPF does not comprise chroma upsampling. If the purpose of the NNPF comprises the chroma upsampling, the color format of the at least one picture is not the first color format.

In some embodiments, if all of the following conditions are met, the at least one indication associated with the chroma input tensor for the NNPF is absent from the bitstream: the color format of the at least one picture is 4:4:4 format, separate plane coding is applied on the at least one picture, and a current input of the NNPF is a luma component of the at least one picture. In the separate plane coding, a plurality of color planes are separately processed as monochrome sampled pictures.

In some embodiments, if all of the following conditions are met, a matrix different from a luma matrix is present in an output tensor of the NNPF: the color format of the at least one picture is 4:4:4 format, the separate plane coding is applied on the at least one picture, a current input of the NNPF is a luma component of the at least one picture, and the color format of the at least one picture is not changed by the NNPF.

In some embodiments, if all of the following conditions are met, a purpose of the NNPF does not comprise chroma upsampling: the color format of the at least one picture is 4:4:4 format, separate plane coding is applied on the at least one picture, and a current input of the NNPF is a luma component of the at least one picture.

In view of the above, the solutions in accordance with some embodiments of the present disclosure can advantageously avoid potential instability and logical issues, and thus the coding efficiency can be improved.

According to further embodiments of the present disclosure, a non-transitory computer-readable recording medium is provided. The non-transitory computer-readable recording medium stores a bitstream of a video which is generated by a method performed by an apparatus for video processing. In the method, a conversion between the video and the bitstream is performed. A neural-network post-processing filter (NNPF) is applied on at least one picture associated with the video. If a color format of the at least one picture is a first color format without a chroma component, at least one indication associated with a chroma input tensor for the NNPF is absent from the bitstream.

According to still further embodiments of the present disclosure, a method for storing bitstream of a video is provided. In the method, a conversion between the video and the bitstream is performed. A neural-network post-processing filter (NNPF) is applied on at least one picture associated with the video. If a color format of the at least one picture is a first color format without a chroma component, at least one indication associated with a chroma input tensor for the NNPF is absent from the bitstream. Moreover, the bitstream is stored in a non-transitory computer-readable recording medium.

Implementations of the present disclosure can be described in view of the following clauses, the features of which can be combined in any reasonable manner.

Clause 1. A method for video processing, comprising: performing a conversion between a video and a bitstream of the video, wherein a neural-network post-processing filter (NNPF) is applied on at least one picture associated with the video, and if a color format of the at least one picture is a first color format without a chroma component, at least one indication associated with a chroma input tensor for the NNPF is absent from the bitstream.

Clause 2. The method of clause 1, wherein the first color format comprises monochrome or 4:0:0 format.

Clause 3. The method of any of clauses 1-2, wherein the at least one indication comprises at least one of the following: a first indication indicating a bit depth of a chroma sample value in the input tensor, at least one second indication indicating at least one of a chroma type or a chroma value used for padding.

Clause 4. The method of clause 3, wherein the first indication comprises a syntax element nnpfc_inp_tensor_chroma_bitdepth_minus8, or the at least one second indication comprises at least one of a syntax element nnpfc_cb_padding_val or a syntax element nnpfc_cr_padding_val.

Clause 5. The method of any of clauses 1-4, wherein if a scheme of ordering sample arrays of one of the at least one picture to form an input tensor to the NNPF indicates no luma matrix is present in the input tensor, a third indication indicating a bit depth of a luma sample value in the input tensor is not present in the bitstream.

Clause 6. The method of clause 5, wherein the scheme of ordering the sample arrays is indicated by a syntax element nnpfc_inp_order_idc, or the third indication comprises a syntax element nnpfc_inp_tensor_luma_bitdepth_minus8.

Clause 7. The method of any of clauses 1-6, wherein if a scheme of ordering sample arrays of one of the at least one picture to form an input tensor to the NNPF indicates no chroma matrix is present in the input tensor, a first indication indicating a bit depth of a chroma sample value in the input tensor is not present in the bitstream.

Clause 8. The method of clause 7, wherein the scheme of ordering the sample arrays is indicated by a syntax element nnpfc_inp_order_idc, or the first indication comprises a syntax element nnpfc_inp_tensor_chroma_bitdepth_minus8.

Clause 9. The method of any of clauses 1-8, wherein in the bitstream, a fourth indication indicating a scheme of ordering sample arrays of one of the at least one picture to form an input tensor to the NNPF precedes at least one of the following: a first indication indicating a bit depth of a chroma sample value in the input tensor, or a third indication indicating a bit depth of a luma sample value in the input tensor.

Clause 10. The method of clause 9, wherein the fourth indication comprises a syntax element nnpfc_inp_order_idc, or the first indication comprises a syntax element nnpfc_inp_tensor_chroma_bitdepth_minus8, or the third indication comprises a syntax element nnpfc_inp_tensor_luma_bitdepth_minus8.

Clause 11. The method of any of clauses 1-19, wherein if an output order of samples from the NNPF indicates no luma matrix is present in an output tensor of the NNPF, a fifth indication indicating a bit depth of a luma sample value in the output tensor is not present in the bitstream.

Clause 12. The method of clause 11, wherein the output order of the samples is indicated by a syntax element nnpfc_out_order_idc, or the fifth indication comprises a syntax element nnpfc_out_tensor_luma_bitdepth_minus8.

Clause 13. The method of any of clauses 1-12, wherein if an output order of samples from the NNPF indicates no chroma matrix is present in an output tensor of the NNPF, a sixth indication indicating a bit depth of a chroma sample value in the output tensor is not present in the bitstream.

Clause 14. The method of clause 13, wherein the output order of the samples is indicated by a syntax element nnpfc_out_order_idc, or the sixth indication comprises a syntax element nnpfc_out_tensor_chroma_bitdepth_minus8.

Clause 15. The method of any of clause s 1-14, wherein in the bitstream, a seventh indication indicating an output order of samples from the NNPF precedes at least one of the following: a fifth indication indicating a bit depth of a luma sample value in an output tensor of the NNPF, or a sixth indication indicating a bit depth of a chroma sample value in an output tensor of the NNPF.

Clause 16. The method of clause 15, wherein the seventh indication comprises a syntax element nnpfc_out_order_idc, or the fifth indication a comprises syntax element nnpfc_out_tensor_luma_bitdepth_minus8, or the sixth indication comprises a syntax element nnpfc_out_tensor_chroma_bitdepth_minus8.

Clause 17. The method of any of clauses 1-16, wherein if a bit depth of a sample value in a color component of an output tensor of the NNPF is greater than a bit depth of a sample value in a corresponding color component of an input tensor of the NNPF, a bit depth of a sample value in each of other components of the output tensor is greater than or equal to a bit depth of a sample value in a corresponding color component of the input tensor.

Clause 18. The method of any of clauses 1-17, wherein if a purpose of the NNPF comprises colorization of the at least one picture, at least one chroma matrix is present in an output tensor of the NNPF.

Clause 19. The method of any of clauses 1-18, wherein if a purpose of the NNPF comprises colorization of the at least one picture, a value of a seventh indication indicating an output order of samples from the NNPF is not equal to a first value.

Clause 20. The method of clause 19, wherein the seventh indication comprises a syntax element nnpfc_out_order_idc, or the first value is 0.

Clause 21. The method of any of clauses 1-20, wherein if a purpose of the NNPF comprises colorization of the at least one picture, the bitstream comprises an eighth indication indicating a color format of an output of the NNPF.

Clause 22. The method of clause 21, wherein the eighth indication comprises a syntax element nnpfc_out_colour_format_idc.

Clause 23. The method of any of clauses 1-22, wherein the bitstream comprises a ninth indication indicating whether a location of a chroma sample in an output of the NNPF is present in the bitstream.

Clause 24. The method of any of clauses 1-23, wherein if a location of a chroma sample in an output of the NNPF is not present in an NNPF Supplemental Enhancement Information (SEI) message in the bitstream, the location of the chroma sample is the same as a location of a chroma sample indicated in video usability information (VUI) in the bitstream.

Clause 25. The method of clause 23, wherein if a purpose of the NNPF comprises colorization of the at least one picture and a color format of the at least one picture is 4:0:0 format, the ninth indication indicates that the location of the chroma sample is present in the bitstream.

Clause 26. The method of any of clauses 1-20, wherein if a purpose of the NNPF comprises colorization of the at least one picture and a color format of the at least one picture is 4:0:0 format, the bitstream comprises an eighth indication indicating a color format of an output of the NNPF.

Clause 27. The method of any of clauses 1-26, wherein if the color format of the at least one picture is the first color format and is not changed by the NNPF, a matrix different from a luma matrix is present in an output tensor of the NNPF.

Clause 28. The method of any of clauses 1-27, wherein if the color format of the at least one picture is the first color format, a purpose of the NNPF does not comprise chroma upsampling, or if the purpose of the NNPF comprises the chroma upsampling, the color format of the at least one picture is not the first color format.

Clause 29. The method of any of clauses 1-28, wherein if all of the following conditions are met, the at least one indication associated with the chroma input tensor for the NNPF is absent from the bitstream: the color format of the at least one picture is 4:4:4 format, separate plane coding is applied on the at least one picture, and a current input of the NNPF is a luma component of the at least one picture.

Clause 30. The method of any of clauses 1-29, wherein if all of the following conditions are met, a matrix different from a luma matrix is present in an output tensor of the NNPF: the color format of the at least one picture is 4:4:4 format, separate plane coding is applied on the at least one picture, a current input of the NNPF is a luma component of the at least one picture, and the color format of the at least one picture is not changed by the NNPF.

Clause 31. The method of any of clauses 1-30, wherein if all of the following conditions are met, a purpose of the NNPF does not comprise chroma upsampling: the color format of the at least one picture is 4:4:4 format, separate plane coding is applied on the at least one picture, and a current input of the NNPF is a luma component of the at least one picture.

Clause 32. The method of any of clauses 1-31, wherein the at least one picture comprises at least one decoded picture or at least one cropped decoded picture of the video.

Clause 33. The method of any of clauses 1-32, wherein the conversion includes encoding the video into the bitstream.

Clause 34. The method of any of clauses 1-32, wherein the conversion includes decoding the video from the bitstream.

Clause 35. An apparatus for video processing comprising a processor and a non-transitory memory with instructions thereon, wherein the instructions upon execution by the processor, cause the processor to perform a method in accordance with any of clauses 1-34.

Clause 36. A non-transitory computer-readable storage medium storing instructions that cause a processor to perform a method in accordance with any of clauses 1-34.

Clause 37. A non-transitory computer-readable recording medium storing a bitstream of a video which is generated by a method performed by an apparatus for video processing, wherein the method comprises: performing a conversion between the video and the bitstream, wherein a neural-network post-processing filter (NNPF) is applied on at least one picture associated with the video, and if a color format of the at least one picture is a first color format without a chroma component, at least one indication associated with a chroma input tensor for the NNPF is absent from the bitstream.

Clause 38. A method for storing a bitstream of a video, comprising: performing a conversion between the video and the bitstream, wherein a neural-network post-processing filter (NNPF) is applied on at least one picture associated with the video, and if a color format of the at least one picture is a first color format without a chroma component, at least one indication associated with a chroma input tensor for the NNPF is absent from the bitstream; and storing the bitstream in a non-transitory computer-readable recording medium.

### Example Device

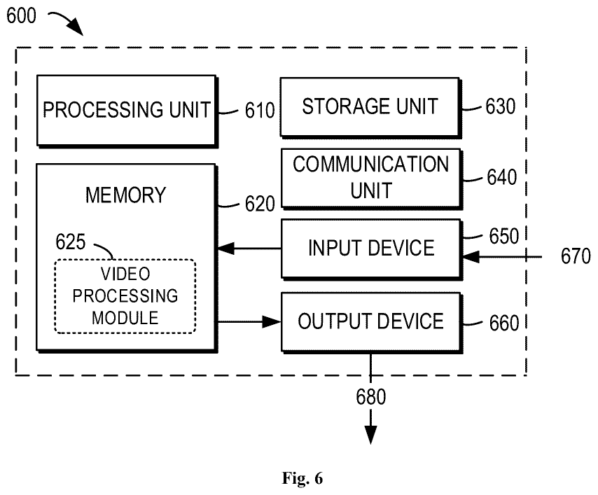

FIG. 6 illustrates a block diagram of a computing device 600 in which various embodiments of the present disclosure can be implemented. The computing device 600 may be implemented as or included in the source device 110 (or the video encoder 114 or 200) or the destination device 120 (or the video decoder 124 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non-volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement video encoding/decoding in embodiments of the present disclosure. The memory 620 may include one or more video coding modules 625 having one or more program instructions. These modules are accessible and executable by the processing unit 610 to perform the functionalities of the various embodiments described herein.

In the example embodiments of performing video encoding, the input device 650 may receive video data as an input 670 to be encoded. The video data may be processed, for example, by the video coding module 625, to generate an encoded bitstream. The encoded bitstream may be provided via the output device 660 as an output 680.

In the example embodiments of performing video decoding, the input device 650 may receive an encoded bitstream as the input 670. The encoded bitstream may be processed, for example, by the video coding module 625, to generate decoded video data. The decoded video data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing a conversion between a video and a bitstream of the video, wherein a neural-network post-processing filter (NNPF) is applied on at least one picture associated with the video, and if a color format of the at least one picture is a first color format without a chroma component, at least one indication associated with a chroma input tensor for the NNPF is absent from the bitstream.

2. The method of claim 1, wherein the first color format comprises monochrome or 4:0:0 format.

3. The method of claim 1, wherein the at least one indication comprises at least one of the following:
a first indication indicating a bit depth of a chroma sample value in the input tensor,
at least one second indication indicating at least one of a chroma type or a chroma value used for padding.

4. The method of claim 3, wherein the first indication comprises a syntax element nnpfc_inp_tensor_chroma_bitdepth_minus8, or
the at least one second indication comprises at least one of a syntax element nnpfc_cb_padding_val or a syntax element nnpfc_cr_padding_val.

5. The method of claim 1, wherein if a scheme of ordering sample arrays of one of the at least one picture to form an input tensor to the NNPF indicates no luma matrix is present in the input tensor, a third indication indicating a bit depth of a luma sample value in the input tensor is not present in the bitstream.

6. The method of claim 5, wherein the scheme of ordering the sample arrays is indicated by a syntax element nnpfc_inp_order_idc, or
the third indication comprises a syntax element nnpfc_inp_tensor_luma_bitdepth_minus8.

7. The method of claim 1, wherein if a scheme of ordering sample arrays of one of the at least one picture to form an input tensor to the NNPF indicates no chroma matrix is present in the input tensor, a first indication indicating a bit depth of a chroma sample value in the input tensor is not present in the bitstream.

8. The method of claim 7, wherein the scheme of ordering the sample arrays is indicated by a syntax element nnpfc_inp_order_idc, or
the first indication comprises a syntax element nnpfc_inp_tensor_chroma_bitdepth_minus8.

9. The method of claim 1, wherein in the bitstream, a fourth indication indicating a scheme of ordering sample arrays of one of the at least one picture to form an input tensor to the NNPF precedes at least one of the following:
a first indication indicating a bit depth of a chroma sample value in the input tensor, or
a third indication indicating a bit depth of a luma sample value in the input tensor.

10. The method of claim 9, wherein the fourth indication comprises a syntax element nnpfc_inp_order_idc, or
the first indication comprises a syntax element nnpfc_inp_tensor_chroma_bitdepth_minus8, or
the third indication comprises a syntax element nnpfc_inp_tensor_luma_bitdepth_minus8.

11. The method of claim 1, wherein if an output order of samples from the NNPF indicates no luma matrix is present in an output tensor of the NNPF, a fifth indication indicating a bit depth of a luma sample value in the output tensor is not present in the bitstream.

12. The method of claim 11, wherein the output order of the samples is indicated by a syntax element nnpfc_out_order_idc, or
the fifth indication comprises a syntax element nnpfc_out_tensor_luma_bitdepth_minus8.

13. The method of claim 1, wherein if an output order of samples from the NNPF indicates no chroma matrix is present in an output tensor of the NNPF, a sixth indication indicating a bit depth of a chroma sample value in the output tensor is not present in the bitstream, or
wherein in the bitstream, a seventh indication indicating an output order of samples from the NNPF precedes at least one of the following: a fifth indication indicating a bit depth of a luma sample value in an output tensor of the NNPF, or a sixth indication indicating a bit depth of a chroma sample value in an output tensor of the NNPF, or
wherein if a bit depth of a sample value in a color component of an output tensor of the NNPF is greater than a bit depth of a sample value in a corresponding color component of an input tensor of the NNPF, a bit depth of a sample value in each of other components of the output tensor is greater than or equal to a bit depth of a sample value in a corresponding color component of the input tensor.

14. The method of claim 1, wherein if a purpose of the NNPF comprises colorization of the at least one picture, at least one chroma matrix is present in an output tensor of the NNPF, or
wherein if a purpose of the NNPF comprises colorization of the at least one picture, a value of a seventh indication indicating an output order of samples from the NNPF is not equal to a first value, or
if a purpose of the NNPF comprises colorization of the at least one picture, the bitstream comprises an eighth indication indicating a color format of an output of the NNPF.

15. The method of claim 1, wherein the bitstream comprises a ninth indication indicating whether a location of a chroma sample in an output of the NNPF is present in the bitstream, or
wherein if a location of a chroma sample in an output of the NNPF is not present in an NNPF Supplemental Enhancement Information (SEI) message in the bitstream, the location of the chroma sample is the same as a location of a chroma sample indicated in video usability information (VUI) in the bitstream, or
wherein the at least one picture comprises at least one decoded picture or at least one cropped decoded picture of the video.

16. The method of claim 1, wherein the conversion includes encoding the video into the bitstream.

17. The method of claim 1, wherein the conversion includes decoding the video from the bitstream.

18. An apparatus for video processing comprising a processor and a non-transitory memory with instructions thereon, wherein the instructions upon execution by the processor, cause the processor to perform acts comprising:
performing a conversion between a video and a bitstream of the video, wherein a neural-network post-processing filter (NNPF) is applied on at least one picture associated with the video, and if a color format of the at least one picture is a first color format without a chroma component, at least one indication associated with a chroma input tensor for the NNPF is absent from the bitstream.

19. A non-transitory computer-readable storage medium storing instructions that cause a processor to perform acts comprising:
performing a conversion between a video and a bitstream of the video, wherein a neural-network post-processing filter (NNPF) is applied on at least one picture associated with the video, and if a color format of the at least one picture is a first color format without a chroma component, at least one indication associated with a chroma input tensor for the NNPF is absent from the bitstream.

20. A non-transitory computer-readable recording medium storing a bitstream of a video which is generated by a method performed by an apparatus for video processing, wherein the method comprises:
performing a conversion between the video and the bitstream, wherein a neural-network post-processing filter (NNPF) is applied on at least one picture associated with the video, and if a color format of the at least one picture is a first color format without a chroma component, at least one indication associated with a chroma input tensor for the NNPF is absent from the bitstream.
